(19) United States
(12) Patent Application Publication
(10) Pub. No.: US 2020/0077642 A1
(43) Pub. Date: Mar. 12, 2020

(54) CRYOPRESERVATION METHOD OF BIOLOGICAL SPECIMEN

(71) Applicant: YISSUM RESEARCH DEVELOPMENT COMPANY OF THE HEBREW UNVERSITY OF JERUSALEM LTD., Jerusalem (IL)

(72) Inventors: Ido BRASLAVSKY, Ness Ziona (IL); Victor YASHUNSKY, Alon Shvut (IL); Amir BEIN, Alfei Menashe (IL); Liat BAHARI, Ness Ziona (IL); Betty SCHWARTZ, Rehovot (IL)

(21) Appl. No.: 16/466,519

(22) PCT Filed: Dec. 5, 2017
(86) PCT No.: PCT/IL2017/051313

§ 371 Date: Jun. 4, 2019

Related U.S. Application Data
(60) Provisional application No. 62/430,588, filed on Dec. 6, 2016.

(51) Int. Cl. A01N 1/02

(52) U.S. Cl. CPC A01N 1/0221; A01N 1/0284

(57) ABSTRACT

The invention relates to a method for cryopreserving a biological sample adhered to a substrate. The method of the invention comprises freezing of adherent cells and/or intact multicellular ensembles, without detaching them from the substrate or from each other. This method utilizes a directional freezing approach, which enables control over ice crystals shape, ice growth rate and position, which have a crucial impact on the physiological revival of the sample upon thawing. The invention further relates to samples cryopreserved according to the method of the invention.

### FIELD OF THE INVENTION

The present invention relates to cryopreservation methods of biological samples. Specifically, the invention relates to a method for cryopreserving a biological sample adhered to a substrate. The invention further relates to samples cryopreserved according to the method of the invention.

### BACKGROUND OF THE INVENTION

Cell cultures are routinely used in many fields, including biomedical research, and are considered indispensable for a variety of applications in basic research, clinical practice, medical diagnostics, and the pharmaceutical industry. The common procedures for utilizing cell cultures in biomed involve isolation of freshly harvested primary cells and the use of immortal established cell cultures. In both cases, only limited number of sub-cultured passages is possible due to changes in cellular characteristics and genetic instability. To overcome this significant limitation, cryopreservation techniques have been developed and over the last decades cryopreservation of different cells types has become a key feature in the routine cell culture work. Cell culturing is a labor-intensive and space-consuming process that involves multiple manipulations of the cell culture. Cryopreserving cells is an important part of the culturing process and is needed to preserve the original cellular characteristics during cell storage over long starches of time. Cryopreservation methods must provide significant survival rates and normal cell functionality in a wide range of cell types after thawing.

Cells are usually cryopreserved while dispersed in specialized freezing solutions. The common procedure of cell-cryopreservation involves several steps, including detachment of adherent cells from a substrate by a proteolytic enzyme (e.g. trypsin), centrifugations and addition of cryopreservative chemicals (also termed “cryoprotective agents”, CPAs), like dimethylsulfoxide (DMSO). This step is followed by a slow freezing protocol (−1° C./min) and storage at −80° C. or −196° C. Thawing the frozen cells is typically a rapid process, which involves additional steps before use. Preparing cell cultures for experiments after thawing may require several days or weeks, depending on the cell type, the cell proliferation rate and other biological processes. In some cases, cell recovery after cryopreservation is especially challenging and time-consuming, for example, among slowly proliferating cells (e.g., embryonic stem cells) and complex cell networks (e.g., neuronal networks or the establishment of polarity in cell culture models of epithelia). Furthermore, several steps which are considered indispensable in cryopreservation may have adverse effects on the cells. For example, addition of intercellular and/or extracellular cryoprotectants to the medium (e.g. DMSO, glycerol, polyethylene glycol (PEG), sucrose, and trehalose) has toxic effects on the cells. Furthermore, today several cell types, such as pluripotent stem cells and primary cells (e.g., primary hepatocytes), might be considered as difficult or even not suitable for routine cell culture use due to the inability of efficiently cryopreserving them.

Development of a method for cryopreserving adherent cells, without the need to disperse them, affords favorable implications on the common cell culture practice, with a significant influence on time and money expenditure. Reducing the percentage of the cryopreservative substances used in the process of freezing is another preferable goal.

Directional freezing was previously reported as an approach for controlling the freezing process. It was also suggested as a method to improve cryopreservation of cells and tissues. This approach however, was demonstrated to be only partially successful and provided inadequate results when used for cryopreservation of adherent cells.

Cell specimens of various types can be found in everyday biomed research, drug screening and pharma R&D, bio-banking and biosensing applications. Thus, the storage of cells is an issue of high importance. To date, to the best of our knowledge, there are no efficient methods for cryopreserving cells that are adhered to a continuous surface, nor products or patents that provide viable adherent cells frozen in their natural morphology. Namely, intact monolayer or tissue attached to a substrate, which can be thawed and revived easily.

It is therefore an object of the invention to provide an efficient, time and cost-effective method for preservation of cells and/or intact multicellular ensembles adhered to a substrate.

It is another object of the invention to provide cryopreserved adherent cells and/or intact multicellular ensembles, ready for use and demonstrating increased revival rates upon thawing.

### SUMMARY OF THE INVENTION

In one aspect, the present invention relates to a method for cryopreservation of a biological sample adhered to a substrate comprising: (a) adding a freezing solution to the biological sample; (b) directionally freezing the sample by moving it along a temperature gradient; and (c) gradually cooling the sample to a temperature selected from a group consisting of: at least −20° C., at least −30° C., at least −60° C., and at least −80° C. In some embodiments, the method further comprises (d) deep cooling the sample to a temperature of between −196° C. to −210° C.

In some embodiments, step (b) is carried out along a temperature gradient selected from the group consisting of: from room temperature to −80° C., from 4° C. to −10° C., and from 4° C. to −2.5° C.

According to a specific embodiment, the step of directionally freezing the sample is carried out on a precooled motorized translational cryostage.

According to one embodiment, step (b) of the method of the invention is carried out at a velocity of 0.1-500 μm/sec. According to a further embodiment, step (b) is carried out at a velocity of 1-100 μm/sec. According to another embodiment, step (b) is carried out at a velocity of 30 μm/sec.

According to a further embodiment, in step (c) the sample is gradually cooled to a temperature of −20° C. at a rate of −1.2° C./min and wherein the sample is further gradually cooled to a temperature of −80° C. at a rate of −0.5-−1° C./min.

In another aspect, the invention relates to a biological sample adhered to a substrate, selected from a primary cell culture, an immortalized cell line culture, a biopsy sample, and a multicellular complex or a combination of multiple cell types.

In some aspects, the substrate is selected from a glass slide, a glass cover-slip, an extracellular matrix, a biocompatible scaffold, Permanox dish or slide, a plastic dish, a multi well plate, a polydimethylsiloxane (PDMS) chip, or a microfluidic chip.

According to a further aspect, the freezing solution comprises a cryoprotective agent selected from DMSO, glycerol, ethylene glycol, polyethylene glycol (PEG), propylene glycol, polypropylene glycol, sucrose, trehalose, dextrose, dextran, polyvinylpyrrolidone, polyvinyl alcohol (PVA) and an ice binding protein. According to a specific embodiment, the cryoprotective agent is DMSO, at a concentration of 5%-10% v/v.

In another aspect of the invention, the sample is preconditioned prior to step (a) by modification of one or more genes, induction of a specific differentiation state, or altered expression of one or more proteins, or any combination thereof.

According to a specific embodiment, the present application relates to a method for cryopreserving a biological sample adhered to a substrate comprising the steps of: (a) adding a freezing solution to the biological sample; (b) directionally freezing the sample by moving said sample along a temperature gradient on a precooled motorized translational cryostage at a velocity of 30 μm/sec, thereby the temperature of the biological sample is reduced from 4° C. to −2.5° C.; (c) gradually cooling the sample on the translational cryostage to −80° C. at a rate of between −0.5° C./min to −1.2° C./min; and optionally (d) deep cooling of the sample to −196° C.

In another aspect, the present invention relates to a cryopreserved biological sample adhered to a substrate.

In a further aspect, the invention relates to a cryopreserved biological sample adhered to a substrate having a revival rate of more than 50% of the cells in the sample upon thawing. According to a specific embodiment, the revival rate is at least 70%-90% of the cells. In some embodiments, the cells in the sample exhibit a modification of one or more genes, a specific differentiation state, or an altered expression of one or more proteins, or any combination thereof.

### BRIEF DESCRIPTION OF THE DRAWINGS

FIGS. 1A-1C are schematic diagrams showing the system enabling the directional cryopreservation method.

FIG. 1A is a schematic layout of the system adapted by the inventors for directional freezing, which includes a motorized translational cryostage (also referred to herein as “stage”) and a commercial inverted microscope. The cryostage comprises two separate thermoelectric coolers (TECs) that are used to set the different temperatures of the “cold” (C) and “hot” (H) copper plates. A motorized actuator moves the specimen on top of the copper plates at a precise velocity toward the cold plate and determines the freezing direction and rate.

FIG. 1B shows temperature map (upper plane) and profile (lower plane) on the surface of the cooper plates separated by air gap (L=2 mm). During the movement of the motorized translational cryostage sample undergoes gradual cooling at the rate proportional to the velocity of sample movement and the temperature difference between the cold and the hot plates. The temperature gradient displays a steep linearity on top of the air gap (inset). The X axis (L) includes a temperature profile along a line in the middle of the cooper plate.

FIG. 1C is a representative image sequence of an ice front growing on a biological sample undergoing directional freezing, in the presence of a 10% dimethyl sulfoxide (DMSO) solution, at 5 seconds interval. The ice front remains in the middle of the imaging frame, while the cells move towards the cold plate. An arrow indicates the location of a specific cell during the movement of the sample. The scale bar indicates 100 μm.

Abbreviations: C (cold); CO (condenser); H (hot); HS (heat sink); L (length, mm); MA (motorized actuator); O (objective); S (sample); Sec (seconds); SM (slide movement); t (time); TMP (temperature, ° C.); TEC (thermoelectric cooler).

FIGS. 2A-2B show the effect of the directional freezing rate on the cell morphology.

FIG. 2A shows ice crystal morphology as a function of the ice front propagation. IEC-18 epithelial cells cultured on a cover glass were subjected to directional freezing on the translational cryostage in the presence of 10% DMSO. Sample movement velocities of 10 μm/sec, 30 μm/sec, and 90 μm/sec are shown. The scale bar indicates 100 μm.

FIG. 2B shows IEC-18 cell morphology prior to freezing, after thawing and after 24 hours incubation at 37° C., as observed in the bright field images. Following directional freezing at sample movement velocities of 10 μm/sec, 30 μm/sec, and 90 μm/sec, IEC-18 cells were cooled to −20° C. at a rate of −1.2° C./min on the translational cryostage. The sample was then transferred to a −80° C. freezer on a copper plate precooled to −20° C. After several days (1-10 days) of storage at −80° C., the sample was thawed and imaged both immediately and after 24 hours. The scale bar indicates 100 μm.

Abbreviations: 24 (24 hours after thawing); AT (after thawing); BF (before freezing).

FIGS. 3A-3E show cells monolayer morphology after directional freezing at various concentrations of DMSO in the freezing medium.

FIG. 3A shows ice crystals during directional freezing (velocity of 30 μm/sec) of adhered IEC-18 cells in the presence of different concentrations of DMSO (0%-10% v/v).

FIG. 3B shows phase contrast images (at ×10 and ×40 magnification) of IEC-18 cells frozen in the presence of different concentrations of DMSO (0%, 2.5%, 5%, 7.5% and 10%), collected immediately after thawing.

FIG. 3C shows phase contrast images (at ×10 and ×40 magnification) of IEC-18 cells frozen in the presence of different concentrations of DMSO (0%, 2.5%, 5%, 7.5% and 10%), collected after 5 hours post-thawing incubation in a humidified, 5% CO₂ incubator, at 37° C.

FIG. 3D shows phase contrast images (×10) of Caco-2 cells frozen in the presence of different concentrations of DMSO (0%, 2.5%, 5%, 7.5% and 10%), collected before freezing, immediately after thawing and after 5 hours post-thawing incubation in a humidified, 5% CO₂ incubator, at 37° C. Scale bar indicates 100 μm.

FIG. 3E shows phase contrast images (×40) of Caco-2 cells frozen in the presence of different concentrations of DMSO (0%, 2.5%, 5%, 7.5% and 10%), collected before freezing, immediately after thawing and after 5 hours post-thawing incubation in a humidified, 5% CO₂ incubator, at 37° C. Scale bar indicates 100 μm. Abbreviations: 5 (5 hours after thawing); AT (after thawing); BF (before freezing).

FIGS. 4A-4B show cell monolayer morphology after directional freezing and different gradual cooling rates from −20° C. to −80° C. Adherent IEC-18 or HeLa cells underwent directional freezing and gradual cooling on the translational cryostage to −20° C., in the presence of 10% DMSO in the freezing medium (v/v). Then, the samples were subjected to gradual cooling to −80° C. on the liquid nitrogen flow cooling stage at rates of −0.5° C./min or −1° C./min. As a control, a sample of each cell line was transferred directly to the −80° C. freezer after reaching −20° C.

FIG. 4A shows phase-contrast images (at ×10 magnification) of IEC-18 monolayers collected prior to freezing, immediately after thawing, and after 5 hours post-thawing incubation in a humidified, 5% CO₂ incubator at 37° C. Scale bar indicates 100 μm.

FIG. 4B shows phase-contrast images (at ×40 magnification) of HeLa monolayers collected prior to freezing, immediately after thawing, after 5 hours post-thawing incubation and after 24 hours incubation in a humidified, 5% CO₂ incubator at 37° C.

Abbreviations: 0.5 (gradual cooling rate of −0.5° C./min from −20° C. to −80° C.); 1 (gradual cooling rate of −1° C./min from −20° C. to −80° C.); 5 (5 hours after thawing); 24 (24 hours after thawing); AT (after thawing); BF (before freezing); D (directly to −80° C.).

FIGS. 5A-5E show the viability of cells subjected to directional freezing using optimized parameters.

FIG. 5A is a schematic diagram showing the optimized freezing procedure. Item (1) is directional freezing of the sample at 30 μm/sec. Item (2) is gradual cooling on the translational stage down to −20° C. at a rate of −1.2° C./min. Item (3) is deep gradual cooling to −80° C., carried out on the liquid nitrogen flow cooling stage at a rate of −0.5° C./min, and optionally transferring the sample to a liquid nitrogen container. Item (4) is the step of storage of the frozen sample at −80° C. Item (5) is the fast thawing step.

FIG. 5B shows Immunofluorescence staining of IEC-18 cells. Cells were fixed in 4% paraformaldehyde before or after directional freezing in a medium containing 10% DMSO, using the optimized parameters of FIG. 5A. Immunofluorescence staining was carried out with phalloidin-TRITC for F-actin framework (red) and 4′,6-Diamidino-2-phenylindole dihydrochloride, (DAPI) for nucleus (blue).

FIG. 5C shows Caco-2 cells monolayer morphology (at ×10 and ×40 magnification) before freezing, immediately after thawing of cells subjected to directional freezing using the optimal parameters described in FIG. 5A, and after 5 hours post-thawing incubation.

FIG. 5D shows bright field and live-dead labeling images (×10) of Caco-2 cells subjected to directional freezing, at 25 minutes and 5 hours after thawing. Adherent Caco-2 cells were labeled using the live/dead kit (green-live/red-dead cells).

FIG. 5E shows bright field and live-dead labeling images (×10) of HeLa cells subjected to directional freezing, at 25 minutes and 5 hours after thawing. Adherent HeLa cells were labeled using the live/dead kit (green-live/red-dead cells).

Abbreviations: 5 (5 hours after thawing); 25 (25 minutes after thawing); AT (after thawing); BF (before freezing); BRF (bright field); COM (combined images of live and dead cells staining); DS (dead cells staining); LS (live cells staining); t (time), TH (thawed cells); TMP (temperature, ° C.); UF (unfrozen).

FIGS. 6A-6D show the viability of HeLa and Caco-2 cells after directional freezing vs. non-directional freezing and slow freezing. Directional freezing (DF) involved a combination of directional cooling at a speed of 30 μm/sec and gradual cooling to −20° C. at −1.2° C./min and then to −80° C. at −0.5° C./min in a freezing medium containing 10% DMSO. Slow freezing (SF) involved solely using gradual cooling at −1° C./min in a freezing medium containing 10% DMSO. Non-directional freezing (NDF) involved the same cooling steps as DF but did not include the directional movement at 30 μm/sec.

FIG. 6A shows bright field images (at ×10 and ×40 magnification) of HeLa cell culture collected prior to freezing and 5 hours after thawing.

FIG. 6B shows bright field images (at ×10 and ×40 magnification) of Caco-2 cell culture collected prior to freezing and 5 hours after thawing.

FIG. 6C shows bright field and live-dead labeling images of Hela and Caco-2 cells subjected to directional freezing, at 5 hours after thawing. Adherent HeLa and Caco-2 cells labeled using the live/dead kit (green-live/red-dead cells). Scale bar indicates 100 μm.

FIG. 6D shows the quantification of live/dead labeling using flow cytometry compared the cell survival percentage obtained under directional freezing (DF), non-directional gradual freezing (NDF, −1° C./min), or direct freezing at −80° C. (D).

Abbreviations: % (survival percent); 5 (5 hours after thawing); BF (before freezing); BRF (bright field); COM (combined images of live and dead cells staining); D (direct freezing to −80° C.); DF (directional freezing); DS (dead cells staining); LS (live cells staining); NDF (non-directional freezing); SF (slow freezing).

### DETAILED DESCRIPTION OF THE INVENTION

The invention relates to a method for cryopreserving a biological sample adhered to a substrate. The method of the invention comprises freezing of adherent cells and/or intact multicellular ensembles, without detaching them from the substrate or from each other. This method utilizes a directional freezing approach, which enables control over ice crystals shape, ice growth rate and position, which have a crucial impact on the physiological revival of the sample upon thawing. The invention further relates to samples cryopreserved according to the method of the invention.

The present invention further provides a product of a biological sample (e.g., frozen adherent cells), in a ready to use state upon thawing.

Currently, there is no product offering frozen adherent cell cultures ready for use shortly after thawing, and there is no method for producing the same.

The present invention is based on the realization that frozen cell specimens that undergo a controlled freezing procedure that imposes minimal damage to the cell structure, can be partially or fully revived by thawing.

The method of freezing for producing said frozen cell specimen is based on directional freezing of adherent cells and/or intact multicellular ensembles without detaching them from the substrate or from each other before freezing, namely, in their normal morphology. This method utilizes gradual freezing of the sample and thus, enables control over ice crystals shape, ice growth rate and position, which has crucial impact on the damage to the sample.

The terms “frozen/freezing” or “cryopreserving” are used herein interchangeably.

Cryopreserving cells in an adherent state, as achieved by the method of the present invention, significantly shortens and simplifies the process of reviving the cells after cryopreservation. This method creates new opportunities for various application, such as bio-banking, and specific in vitro cell-based assays. For example, cryopreservation of adherent cells facilitates direct storage in microfluidic devices (e.g. cells/organs on a chip), and the preservation of small numbers of cells, while reducing the need for extended proliferation periods after thawing.

As in the cryopreservation of dispersed cells, the cryopreservation of adhered cells faces challenges associated with avoiding lethality, particularly within intermediate freezing temperatures (−15° C. to −60° C.). Major damage to cells during freezing and thawing is typically related to intracellular ice formation and osmotic injury due to exposure of cells to high levels of electrolytes. Moreover, intact cells share cell-cell junctions, such as gap junctions that allow direct water exchange between cells; therefore, intercellular freezing can cause the sequential freezing of adjacent cells.

The method of freezing adherent cell cultures according to the present invention is a combination of directional freezing and gradual cooling. Directional freezing was never applied previously successfully for cryopreservation of adherent cells. An attempt to preserve adherent neuron-like cells with directional freezing was not successful (Uemura and Ishiguro, Cryobiology 2015; 70(2):122-35).

Thus, in one aspect, the present invention concerns a method for cryopreserving a biological specimen. The cell sample, which is an intact cell culture adhered to a substrate is frozen on a cooling stage with controlled temperature gradient. The cell sample gradually cools down by entering into a cold region at a controlled rate allowing freezing of extracellular fluid but avoiding intracellular freezing.

The combination of directional freezing and gradual cooling according to the invention helps avoiding freezing damages that arise from uncontrolled intracellular ice formation which occurs in conventional freezing methods when the freezing medium is at a liquid state below the freezing temperature (super cooled liquid) is used. It also enables the control over ice crystal size and shape that are formed in the sample during the freezing process, and reduces the total freezing time. By controlling the ice crystal size and shape it is possible to decrease the physical damages to the membrane and internal cells organelles. The control over the extant and duration of freezing enables the reduction of the toxic effects due to local high solutes concentrations during the freezing process.

The freezing medium can contain cryopreservants, such as DMSO, dextran or other additives (e.g. organic and inorganic ice shaping additives).

Accordingly, the present invention provides a method for cryopreservation of a biological sample adhered to a substrate comprising:
(a) adding a freezing solution to the biological sample;
(b) directionally freezing the sample by moving it along a temperature gradient; and
(c) gradually cooling the sample to a temperature selected from a group consisting of: at least −20° C., at least −30° C., at least −60° C., and at least −80° C.

In some embodiments the method of the invention further comprises step (d)—deep cooling the sample to a temperature of between −196° C. to −210° C.

In a specific embodiment of the method of the invention, the directionally freezing of the sample is carried out on a precooled motorized translational cryostage.

According to a specific embodiment, the cryopreservation method of the biological sample according to the invention comprises the following steps:
(a) adding a freezing solution to the biological sample;
(b) directionally freezing;
(c) gradually cooling to −20° C.;
(d) gradually cooling to −80° C.; and optionally
(e) deep cooling to −196° C.

The frozen sample according to the invention is stored for any desired time-period until physiological revival of the biological sample.

According to a specific embodiment, the method of the invention includes tight control of ice formation in the sample by movement of the sample on a temperature gradient.

The gradual cooling steps (c) and (d) could be executed in the same configuration (for example, if the cooling stage is set to −80° C.) or with separate deeper cooling setups.

The cryopreservation method in the context of the present invention refers to the following temperatures and time-periods of maintaining the cells:
1) Single cells or multicellular complexes adhered to a substrate preserved at −196° C. for long time (up to several years) in their original morphology and reused after thawing.
2) Single cells or multicellular complexes adhered to a substrate preserved at −80° C. up to a few months and reused after thawing.
3) Single cells or multicellular complexes adhered to a substrate preserved at −20° C. for few days and reused after thawing.

The biological sample (also termed herein “biological specimen”) according to the invention is selected from a primary cell culture, an immortalized cell line culture, a biopsy sample, and a multicellular complex, or any other type of cell or combination of multiple cell types that need to be grown on a substrate in order to function.

The term “substrate” as used herein refers to any surface or matrix suitable to hold a biological specimen, such as glass slides, glass cover-slips, extracellular matrix, biocompatible scaffolds, Permanox and other biocompatible materials such as plastic dishes and multi well plates, polydimethylsiloxane (PDMS) chip and a microfluidic chip.

The term “freezing solution” as used herein refers to any type medium suitable for maintaining biological samples. The freezing solution may comprise a cryopreserving agent.

The method for freezing a biological specimen according to the invention is further characterized by the lack of need for cell dissociation agents, as typically required in currently used cryopreservation methods. Therefore, the cell culture or tissue frozen according to the invention remains in its normal morphology throughout the freezing and thawing procedures.

In addition, the freezing is achieved in a gradual manner by a controlled rate. Therefore, the size, growth rate, shape and location of the ice crystals are controlled during the specimen freezing.

Furthermore, the amounts of cryopreservation agents used in the method of the invention are similar or lower than the amounts routinely used in state of the art freezing procedures.

The term “dissociating agent” as used herein refers to any material, which is able to dissociate adherent cells from their culture vessel, thus resulting in suspended cells.

Non-limiting examples of dissociating agents are proteolytic enzymes (e.g., trypsin) and calcium chelators (e.g., EDTA or EGTA).

The term “cryopreserving agent” or “cryoprotective agent” as used herein refers to a material that reduces the amount of ice formed during the freezing process, by increasing the total concentration of all solutes in the sample. CPAs are characterized by low molecular weight and low toxicity. CPAs are divided into two main classes: intracellular agents, which penetrate inside the cell and prevent the formation of ice crystals that could result in membrane rupture, and extracellular agents that do not penetrate through cell membranes and act to improve the osmotic imbalance that occurs during freezing. Non-limiting examples of CPAs are DMSO, glycerol, ethylene glycol, polyethylene glycol (PEG), propylene glycol, polypropylene glycol, sucrose, trehalose, dextrose, dextran, polyvinylpyrrolidone, ice shaping additives such as polyvinyl alcohol (PVA) and an ice binding proteins.

In step (a) of the method according to the invention a freezing solution is added to the biological sample to be cryopreserved, which is either adhered to a substrate and/or the cells are attached to each other.

During the directional freezing step of the method (step (b)), the freezing of the sample is carried out in a system adapted for this purpose, which includes a translational cryostage (also referred to herein as “stage”) under a commercial inverted microscope, which facilitates real-time visualization of cells and ice crystals during this freezing step.

In step (b) of the method of the invention, the translational cryostage is precooled to create a frozen drop of distilled water, thereby an initial ice nucleus is introduced to the sample when the same is placed on the stage.

In one embodiment according to the invention, the translational cryostage is a motorized translational cryostage, which is equipped with two individually controlled thermoelectric coolers that enable the facilitation of a temperature gradient along the two bases of the stage. During the movement of the motorized translational cryostage, the sample undergoes gradual cooling at a rate proportional to the velocity of the sample movement and the temperature difference between the cold and the hot bases.

Accordingly, the sample moves along the temperature gradient from the “hot” thermal base towards an area of lower temperature, namely the “cold” thermal base, resulting in the entire sample being covered by ice crystals. Each thermal base includes a heat sink, thermoelectric cooler, and a temperature measurement element. In a different embodiment, the two bases can share the same heat sink.

The setting of the temperature gradient may vary depending on the type of the biological sample (e.g., adherent cells, biopsy specimens, etc.). Step (b) of the method of the invention is carried out along a temperature gradient selected from the group consisting of: from room temperature to −80° C., from 4° C. to −10° C., and from 4° C. to −2.5° C.

In some embodiments the determination of the temperature gradient is based on the freezing temperature of the specific freezing medium used, so that the temperature of the “hot” thermal base is above said freezing temperature, and the temperature of the “cold” thermal base is below said freezing temperature. For example, for in cases when 10% v/v DMSO is used as the freezing solution, the “hot” and “cold” thermal bases are set at −2° C. and −8° C., respectively.

In another embodiment according to the invention, directionally freezing the sample (step (b)) is carried out on a stationary translational cryostage, which gradually cools the biological sample at a constant rate without moving the sample.

During the gradual cooling step of the method of the invention (step (c)), further lowering of the sample temperature is achieved without moving the sample. In this step, the sample is gradually cooled to a temperature of at least −20° C., preferably at least −30° C., more preferably at least −60° C., and most preferably at least −80° C.

In one embodiment, in step (c) the sample is gradually cooled on the translational cryostage to −80° C. at a rate of between −0.5° C./min to −1.2° C./min.

In another embodiment according to the invention, in step (c) the sample is gradually cooled to a temperature of −20° C. at a rate of −1.2° C./min. The sample may be further gradually cooled to a temperature of −80° C. at a rate of −0.5-−1° C./min.

In yet another embodiment, the sample is gradually cooled to at least two temperatures, the second temperature being lower than the first temperature, and the third temperature being lower than the second temperature, etc. In some embodiments, the first temperature is between −15° C. and −30° C., and the second temperature is between −65° C. and −90° C. The method may also comprise deep cooling of the sample to a third temperature of between −196° C. to −210° C.

According to a specific embodiment, in step (c) the temperature of the stage is gradually reduced down to −20° C. Next, the sample is further cooled to −80° C. on a liquid nitrogen flow cooling stage. Finally, the sample is submerged in liquid nitrogen chamber at −196° C.

The method according to the invention may further comprise step (d), deep cooling of the sample to a temperature of between −196° C. to −210° C.

Non-limiting examples of the cooling procedures include the following freezing velocities: In step (b), the directional freezing step is carried out at a translational velocity of 0.1-500 μm/sec, specifically 1-100 μm/sec, and preferably 30 μm/sec (corresponding to a freezing rate of −3.8° C./min).

In step (c) the sample is gradually cooled on the translational stage down to −80° C. at a rate of between −0.5° C./min to −1.2° C./min.

In some embodiments, in step (c) the sample is gradually cooled on the translational stage down to −20° C. at a rate of −0.02° C./sec (corresponding to −1.2° C./min).

In other embodiments the sample is further cooled down to −80° C. at a rate of −0.5-−1° C./min.

It should be noted that the step of gradually cooling the sample can be achieved by lowering the temperature of the sample at a constant rate to any temperature selected from of a group consisting of: at least −20° C., at least −30° C., at least −60° C., and at least −80° C.

According to a specific embodiment, the invention provides a method for cryopreserving a biological sample adhered to a substrate comprising the steps of:
(a) adding a freezing solution to the biological sample;
(b) directionally freezing the sample by moving said sample along a temperature gradient on a precooled motorized translational cryostage at a velocity of 30 μm/sec, thereby the temperature of the biological sample is reduced from 4° C. to −2.5° C.;
(c) gradually cooling the sample on the translational cryostage to −80° C. at a rate of between −0.5° C./min to −1.2° C./min; and optionally
(d) deep cooling the sample to −196° C.

The cryopreserved biological sample prepared according to the method of the invention is maintained frozen at a temperature of −80° C. for up to 12 months or at −196° C. for up to 15 years, until thawing.

In certain embodiments of the invention, the biological sample may be preconditioned prior to the cryopreservation process by any cell modification including transient and permanent modifications, such as modification of one or more genes, induction of a specific differentiation state, or altered expression of one or more proteins, or any combination thereof.

Non-limiting examples of gene modifications are for example, expression of an exogenous gene or protein (such as GFP and viral genes), overexpression or downregulation of an endogenous gene or protein and expression of a mutated gene or protein.

The main advantages of the method of the invention are:
a) Improving cryopreservation procedure by obviating steps in routinely used freezing methods (i.e. cell dissociation).
b) Introduction of faster and cheaper protocols for cell culture utilization, for example thawing a slide and executing an experiment on the next day.
c) A significant reduction in time (and money) consumption needed for executing experiments where differentiation of the cells is a prerequisite (for example, 15-21 days for Caco-2 cells). The present invention provides a supply of differentiated cells ready for use.
d) Similarly to (c), any pre-conditioning, treatment, gene or protein modifications can be applied to the cells before freezing, thus saving both time and money expenditure for the end user.
e) Similarly to (c) and (d), the method of the invention provides a ready for use co-culture of different cell types.
f) Standardization of cells utilized for conducting in-vitro experiments. The invention provides cells quality controlled for different parameters, such as passage number, confluency, gene and protein expression etc., to ensure minimum variations in the results and conclusions drawing.
g) Lowering the concentrations of toxic cryopreservation chemicals, such as DMSO, and enabling the utilization of cells types which are not in use today because of the difficulty or inability to freeze them.
h) Elimination of the essential need for liquid nitrogen (by the end user) due to availability of ready to use specimens at −80° C.

Thus, by another aspect, the present invention concerns a frozen biological specimen characterized by the following features: First, after seeding and before freezing, cell dissociation does not take place, so that the cells are adhered to a substrate and/or to each other as can be determined by microscopy. As the sample was not treated by any dissociation agent, contrary to any other shipped specimens, the frozen specimen of the invention does not contain traces of dissociation agents, such as proteolytic enzymes (e.g., trypsin) as well as calcium chelators (e.g., EDTA or EGTA).

Second, due to the directional freezing process, lower than usual amounts of cryopreservation agents, such as DMSO, dextran, ice shaping additives such as polyvinyl alcohol (PVA) and ice binding proteins, glycerol, PEG, sucrose, trehalose, etc. might be used. This means that while in routine, state of the art methods, a certain percentage of cryopreservation agents can be found, in the specimen of the invention, the amount of cryopreserving agents that is found can be 50% lower than said routine percentage for obtaining similar viability of the sample after thawing. It should be noted that the amount of cryopreserving agents is dependent upon the cell type or biological origin.

Specifically, while the amount of DMSO present in cryopreserved IEC-18 or Caco2 cells produced according to routine methods, is at least 10% of the freezing solution (v/v), the amount of DMSO in the freezing solution used according to the present invention is reduced to 5%-10% v/v, for example 7.5% v/v.

Third, as the specimens are maintained in an adherent state, the specimens can be preconditioned in various ways, such as but not limited to gene modification, differentiation and protein expression. These long preparations can be performed before freezing the sample and save time at the user's end. The resulting cryopreserved biological sample exhibits a modification of one or more genes, a specific differentiation state, or an altered expression of one or more proteins, or any combination thereof.

Finally, the specimens are characterized by the fact that upon thawing a high percentage of cells are revived and demonstrate normal morphology and functionality similar to the morphology and functionality of the cells before they underwent the cryopreservation method according to the invention. Preferably, at least 50% of cells are physiologically revived upon thawing, corresponding to a revival rate of more than 50% of the cells in the sample upon thawing. More preferably, at least 70%, and most preferably, at least 90% of the cells are revived upon thawing. With multicellular specimens, the specimen is characterized by high functionality after thawing in similar percentages to the percentage of revival of cells frozen in suspension. In addition, the samples show immediate or up to a few hours revival, with no need for long re-adaptation period.

Physiological revival can be determined by testing one or more of the following parameters:
1) Attachment of cells to the substrate assessed by bright field microscopy captures of cell morphology;
2) Cell-cell attachment assessed by bright field microscopy captures of cell morphology;
3) Cellular membrane integrity assessed with live cell imaging by tracing internalization of membrane impermeable marker or by immunofluorescence staining with a “LIVE/DEAD” kit (as specified in the examples hereinbelow).
4) Integrity of cytoskeleton and adhesion structures assessed by immunofluorescence staining.
5) Low level of apoptotic markers assessment by protein analysis methods, such as Western Blot.
6) Additionally, samples can be checked for ice morphology within the sample using Cross polarized microscopy.

The cryopreserved cells according to the present invention show upon thawing almost immediate revival, and do not require many days of re-adaptation and proliferation.

The cryopreserved sample of the invention may be used in the various applications, such as:
“Live cell” applications: instant cell culture kits, genetically modified cells expressing non-native genes and proteins (e.g. fluorescent markers specialized for different cells assays), genetically modified cells not expressing native genes and proteins (down regulation/silencing), kits for drug screening and biosensing.
“Fixed cell” application: Frozen cell specimens can be used for various immunoassays without thawing directly by solvent exchange in the frozen state. Namely, by exchanging the ice with organic solvent at low temperature (e.g. −20° C., −80° C.).

The biological sample cryopreserved according to the present invention enables the transport of a frozen product adhered to substrate (e.g., on slides, dishes or chips).

The invention will now be described with reference to specific examples and materials. The following examples are representative of techniques employed by the inventors in carrying out aspects of the present invention. It should be appreciated that while these techniques are exemplary of specific embodiments for the practice of the invention, those of skill in the art, in light of the present disclosure, will recognize that numerous modifications can be made without departing from the spirit and intended scope of the invention.

### EXAMPLES

### Example 1

### Materials and Methods

### Cell Culture

The rat Ileum epithelium cell line IEC-18 (courtesy of Prof. Betty Schwartz, The Hebrew University of Jerusalem, Israel) was cultured in Dulbecco's Modified Eagle's Medium (DMEM; Sigma-Aldrich, Inc., St. Louis, Mo., USA) supplemented with 10% (v/v) Fetal Bovine Serum (FBS, SAFC Biosciences Lenexa, Kans., USA), 1% (v/v) L-Glutamine (Biological Industries, Beit Haemek, Israel) and 1% (v/v) Penicillin-Streptomycin Solution (Biological Industries). Human intestinal Caco-2 cells (purchased from the American Type Cell Culture collection (ATCC)) were cultured in DMEM (Sigma-Aldrich) supplemented with 20% (v/v) FBS (SAFC Biosciences) and 1% (v/v) Penicillin-Streptomycin Solution (Biological Industries). The human cervical cancer HeLa cell line (courtesy of Prof. Shpigel, The Hebrew University of Jerusalem, Israel) was cultured in DMEM medium (Sigma-Aldrich) supplemented with 10% (v/v) FBS (Biological Industries) and 1% (v/v) penicillin-streptomycin solution (Biological Industries). All cells were grown at 37° C. in humidified atmosphere containing 95% air and 5% CO₂.

### Directional Freezing Concept and Methodology

Concept: one of the main obstacles for successful cryopreservation of cells is the irreversible damage to cells organelles and membranes caused by uncontrolled growth of ice dendrites in super-cooled liquid. Since the freezing regime imposes critical influence over formation and structure of ice crystals, a precise setting of the freezing rate and direction facilitates the control over ice crystals shape and size, consequently affecting cells fate. Directional freezing reduces the profound mechanical damages caused to the cells during the freezing process. In this method the sample gradually enters into the cold zone thereby causing the ice to form and propagate backwards inside the sample. In this freezing configuration no significant super-cooling occurs and ice formation and structure are tightly controlled by the freezing rate.

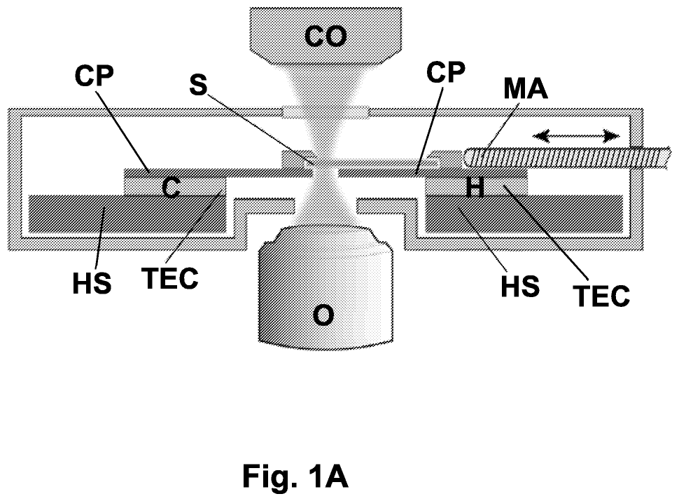

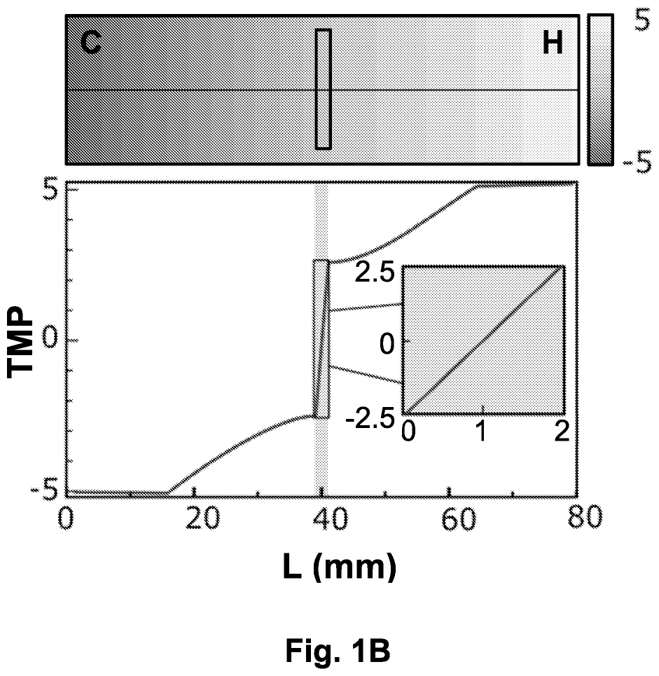

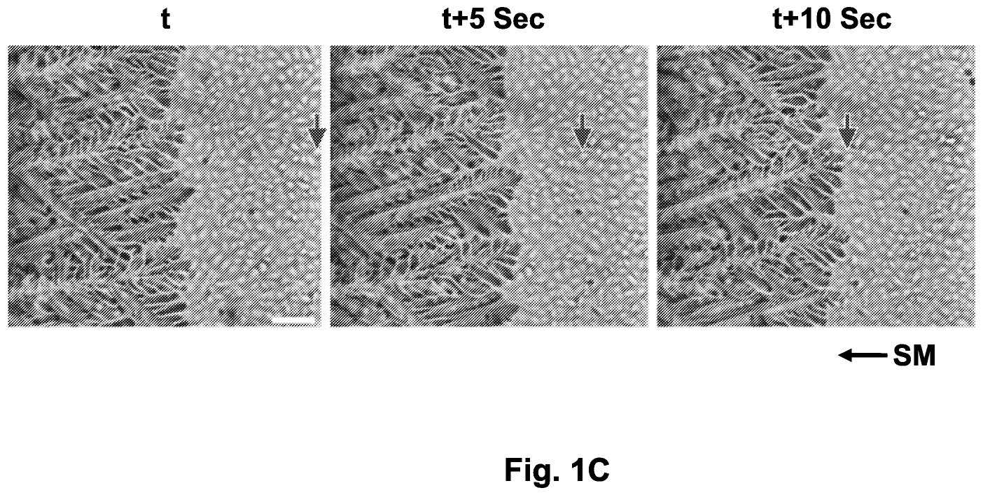

Methodology: A unique cooling stage was especially designed and fabricated for this purpose. As shown in FIG. 1A, the cooling core of the stage consisted of two copper plates separated by a 2 mm air gap (slit). The stage was equipped with two individually controlled thermal bases (“Hot” and “Cold”), wherein the surface temperatures could be independently controlled using a high-precision proportional-integral-derivative (PID) temperature controller (PRO800 system with two TED8020 modules, ThorLabs). Cooling was performed using a Peltier thermoelectric cooler (06311-5L31-02CFL, Custom Thermoelectric, USA), and the temperature was measured using a 10 kΩ Thermistor (G1540, EPCOS AG, Germany). A desired temperature gradient along the sample surface for unidirectional freezing was created by setting the “Hot” and “Cold” bases temperatures above and below the freezing temperature of the cells medium, respectively. COMSOL Multiphysics® simulation results modeled the unidirectional temperature field gradient across the thermal bases. As shown in FIG. 1B, the temperature gradient within the slit could be expressed as ∇T=α·(Tₕ−T_{c})/d, where in d is the width of the slit between the thermal bases and α=0.7 is a prefactor that depends on the thermal conductivity and specific geometry of the slit. The movement speed (ν) of the glass slide on top of the slit was adjusted using a linear actuator (TRA25CC, Newport, USA) that enabled continuous imaging of the ice front without moving the CCD camera (DMK 23U618, The Imaging Source, Germany). Custom LabVIEW software was written to simultaneously control the sample's position, movement speed, temperature of the individual bases, and image acquisition. To avoid water condensation on the cryostage, the cryostage was purged with cold dry air at a rate of 0.1 L/min. An initial ice nucleus was introduced into the sample by a frozen sterile water drop positioned at the sample's edge. The sample was then carefully moved towards the “cold” base of the stage, resulting in ice growth at a rate directly correlated to the sample movement velocity, typically 30 μm/sec. The movement velocity and thermal gradients employed were relatively low; therefore, the existence of a steady-state temperature distribution during sample motion could be assumed. Under these conditions, the velocity of the ice front was determined by the velocity of the sample movement across the temperature gradient, which produced a stationary ice front within the moving frame of the camera (FIG. 1C). Conventional freezing methods are typically described in terms of the freezing rate; therefore, the freezing rate (R) is defined as R=ν∇T. The stage was designed to fit a commercial inverted microscope to facilitate real-time visualization of cells and ice crystals during the freezing process. The stage fitting to the microscope supported the use of long working distance objectives up to ×50, with a numerical aperture of 0.55, thus providing a resolution down to 0.5 μm.

The liquid nitrogen flow cooling stage was used to gradually cool the samples to −80° C. The stage consisted of an aluminum block (80 mm×80 mm×20 mm) with a 10 mm diameter U-shape flow channel, a 5 mm thick copper plate attached by screws on top of the aluminum block, and a thermocouple placed on top of the copper plate. The assembly was thermally isolated from the bottom and sides using PVC foam. The flow and evaporation of the liquid nitrogen inside the aluminum block cooled the copper plate. During cooling, the sample was placed on top of the copper plate and covered with a polycarbonate box that was purged with dry air to avoid condensation of water onto the sample. The cooling profile was regulated using a LabVIEW PID loop feedback that controlled the flow rate of liquid nitrogen using a cryogenic solenoid valve (VCW31-5C-5-02N-C-Q, SMS, Japan).

### Cells Freezing and Thawing

The translational cryostage was cooled to create a frozen drop of distilled water on top of a thin glass slide (0.17 mm thick) that was positioned on top of the stage. The temperatures of the thermal bases were set according to the freezing point of the freezing medium composition. Confluent IEC-18, Caco-2 or Hela cells, grown on 11 or 18 mm Ø glass cover slips in 24 or 12 well plates (Thermo Fisher Scientific—Nunc A/S, Waltham, Mass., USA) were transferred to 60 mm culture dishes (Thermo Fisher Scientific) pre-filled with 2.5 ml freezing medium containing 90-100% DMEM culture medium, fully supplemented as mentioned above and 0-10% dimethyl sulfoxide (DMSO). After 5 minutes incubation in the freezing medium, the coverslip covered with a cell monolayer was placed in the freezing stage on top of the thin glass slide. The coverslip with cells was placed in a downwards manner (cells facing down) at the edge of a frozen drop of water so that the cells were in contact with the frozen drop to provide an initial nucleation site and covered on both sides to prevent contamination. The temperature gradient setting was set according to the freezing point of the cells medium, for example for 10% DMSO −2° C. and −8° C. on “hot” and “cold” bases were set respectively. Next, linear movement of the coverslip was initiated on the stage between the two thermal bases. Different sample movement velocities were tested in the range of 0.1 μm/sec to 500 μm/sec. Best results were obtained when using movement velocities of 10 μm/sec, 30 μm/sec and 90 μm/sec. Ice crystals formation and real time changes of the sample during the unidirectional freezing process were captured on video with a CMOS camera for further analysis.

Upon completion of the directional freezing process, the temperature of the sample was equalized to the temperature of the cold thermal base (for example, −8° C. in the presence of 10% DMSO). Freezing continued according to the following steps: (1) intermediate freezing down to −20° C. at −1.2° C./min, carried out on the translational freezing stage and (2) cooling down to −80° C., which was performed by transferring the sample onto 50 mm Ø, 4.5 mm thick copper plates pre-cooled to −20° C. to a −80° C. freezer, where the sample was kept for 16-24 hours, or, alternatively, by transferring the frozen sample onto the liquid nitrogen flow cooling stage pre-cooled to −20° C. and then decreasing the temperature gradually to −80° C. at a rate of −0.5° C./min or −1° C./min, before storing the frozen sample at −80° C. for at least 24 h until thawing. The cooling can be done in one step as well, from −8° C. to −80° C. directly with a rate of −1.2° C./min or even faster.

### Cell Revival:

For thawing, the samples were transferred from the −80° C. freezer to 60 mm culture dishes (Thermo Fisher Scientific) pre-filled with warmed (37° C.) DMEM culture medium, fully supplemented as mentioned above, and cultured at 37° C. in humidified atmosphere containing 95% air and 5% CO₂. Pre- and post-freezing bright field images of the cells were captured using an Eclipse TS100 microscope (Nikon, Tokyo, Japan) using 10× and 40× air objectives.

The different parameters mentioned herein, such as freezing stage temperatures, sample movement velocity etc., were used to produce the preliminary data supplied.

After being cooled to −80° C., the sample can be further cooled down to −196° C. and kept in a liquid nitrogen chamber to allow long time storage.

### Immunofluorescence

IEC-18, HeLa or Caco-2 cells (seeded at 1.5×10⁵ cells per well) were grown on 18 mm Ø glass cover slips and frozen as described above. At the end of the experiment, the cells were fixed in 3.7% (w/v) paraformaldehyde solution, washed with phosphate-buffered saline (PBS) and incubated with Phalloidin-TRITC (Sigma-Aldrich) for F-actin staining and Dapi (Sigma-Aldrich) for nucleus staining. After washing (×4) with tris-buffered saline+Tween-20 solution (TBST), the cover slips were mounted on glass slides using Fluoro-Gel with DABCO (Electron Microscopy Sciences Hatfield, Pa., USA). Fluorescent pictures were captured with the Eclipse E400 fluorescent microscope (Nikon, Tokyo, Japan).

### Live/Dead Assay and FACS Analysis

The live/dead assay was conducted using a commercial kit (ab115347, Abcam, Cambridge, UK) according to the manufacturer's protocol. Briefly, the cover slips covered with the cells were transferred to 12 or 24 well plates and thawed as described above. The kit solution was mixed with PBS to produce a 1× final concentration and added to the thawed cells. After 10-15 minutes incubation at 37° C., live/dead staining was visualized using an inverted epifluorescence microscope (Olympus IX51) with a ×20 objective. LIVE (green): excitation 495 nm, emission: 510-550 nm, dichromatic mirror 505 nm, DEAD (red): excitation 510-550 nm emission >590 nm, dichromatic mirror 570 nm.

For fluorescence-activated cell sorting (FACS) analysis, the thawed cells were detached from the coverslip by trypsin treatment (Biological Industries), collected, and centrifuged. The pellet was re-suspended in a 1× solution of the dye mix and incubated for 15-60 minutes. The samples were analyzed using a FACSAria III (Becton, Dickinson, N.J., USA). Forward scatter (FSC) versus side scatter (SSC) and fluorescein isothiocyanate (FITC) versus propidium iodide (PI) plots were generated from the standard FACS analysis results. 5000-10000 cells were analyzed per sample.

### Example 2

### Cell Recovery is Dependent on Freezing Rate

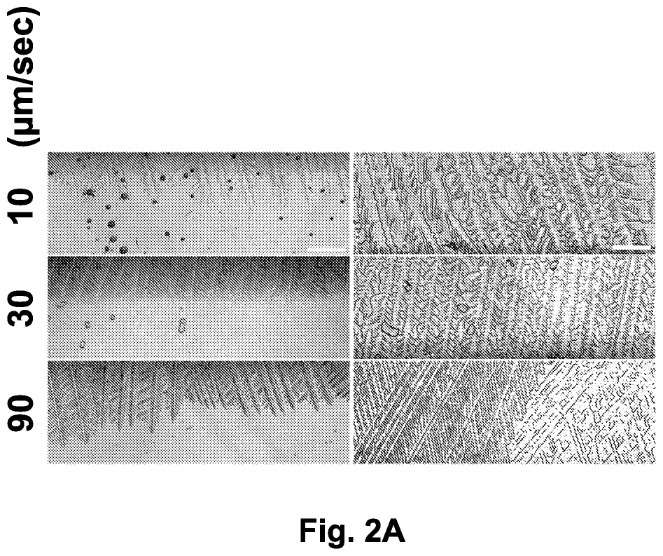

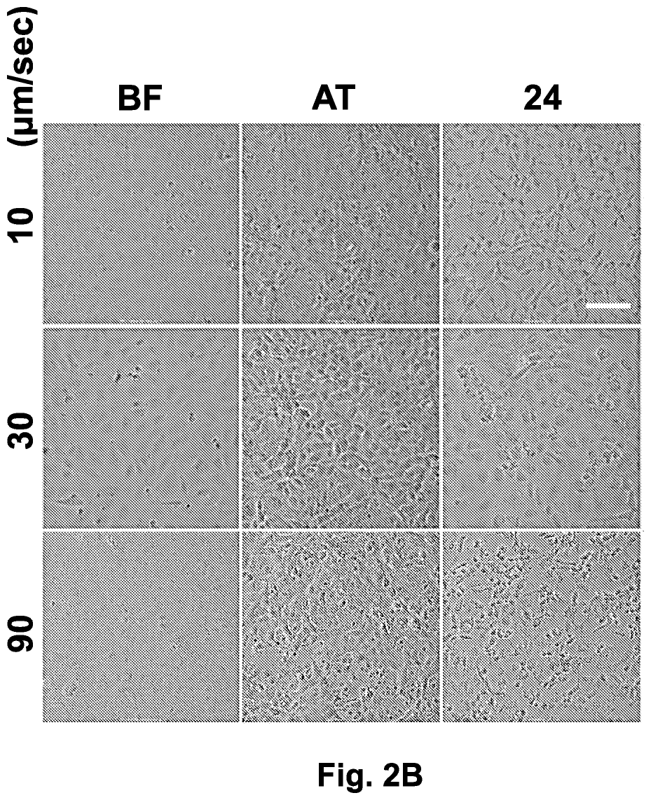

First, the influence of the sample movement velocity, which affects both the ice crystal shape and the cooling rate was examined. FIG. 2A shows the shape of the ice crystals formed at different velocities: 10 μm/sec, 30 μm/sec, 90 μm/sec (corresponding to freezing rates of −1.3° C./min, −3.8° C./min, and −11.3° C./min, respectively). Increasing the velocity amplified the branching of the ice crystals and decreased their width (FIG. 2A, left panel). By the end of the directional freezing, denser ice crystal texture was observed at higher velocities (FIG. 2A, right panel).

Next, the effect of the directional freezing rate on the morphology of the confluent IEC-18 cell monolayers, as an indicator of the cell recovery/viability, was investigated. Several velocities over a constant gradient were examined. Phase contrast images collected immediately after thawing showed a decrease in cell area and a greater contrast at the cell boundaries, indicating on osmotic shrinkage (FIG. 2B). Cells that were exposed to faster directional freezing (90 μm/sec) displayed dark cytosol, typical of intracellular freezing, as well as disrupted monolayers with multiple voids. Images collected 24 hours post-thawing incubation revealed that most of the cells that were frozen at 10 μm/sec and 90 μm/sec were not viable, based on their dark and faceted morphologies. Conversely, cells that were frozen at 30 μm/sec appeared normal with rounded cell morphologies. These cells also remained viable after up to a week of incubation. Remarkably, the cells remained adhered to the substrate at all freezing rates, even if they were not viable.

### Example 3

### Assessing the Minimum Concentration of DMSO Needed for Successful Cryopreservation

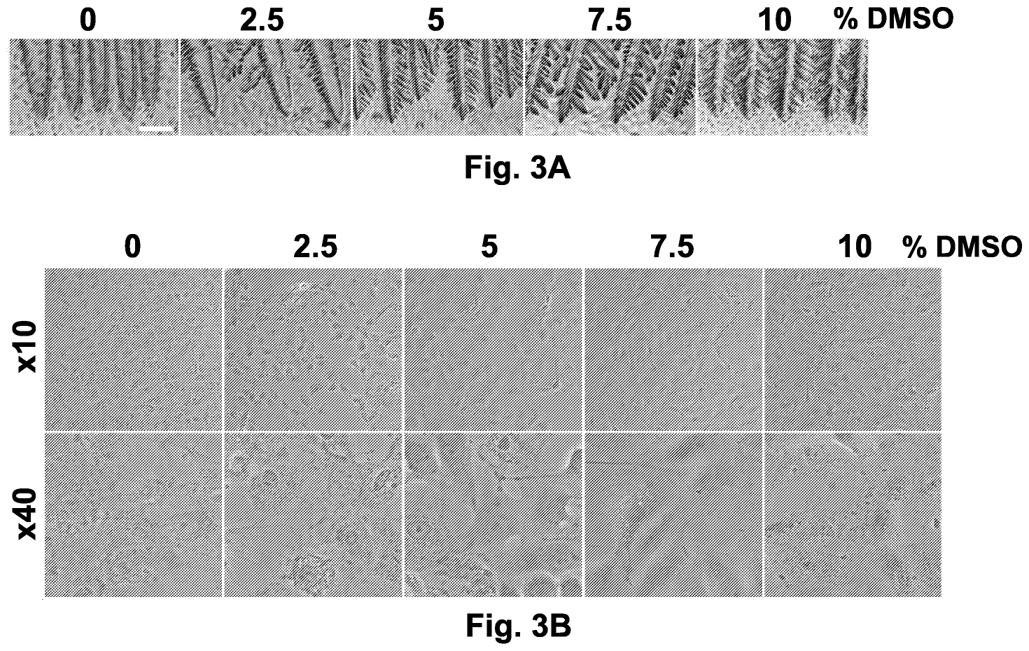

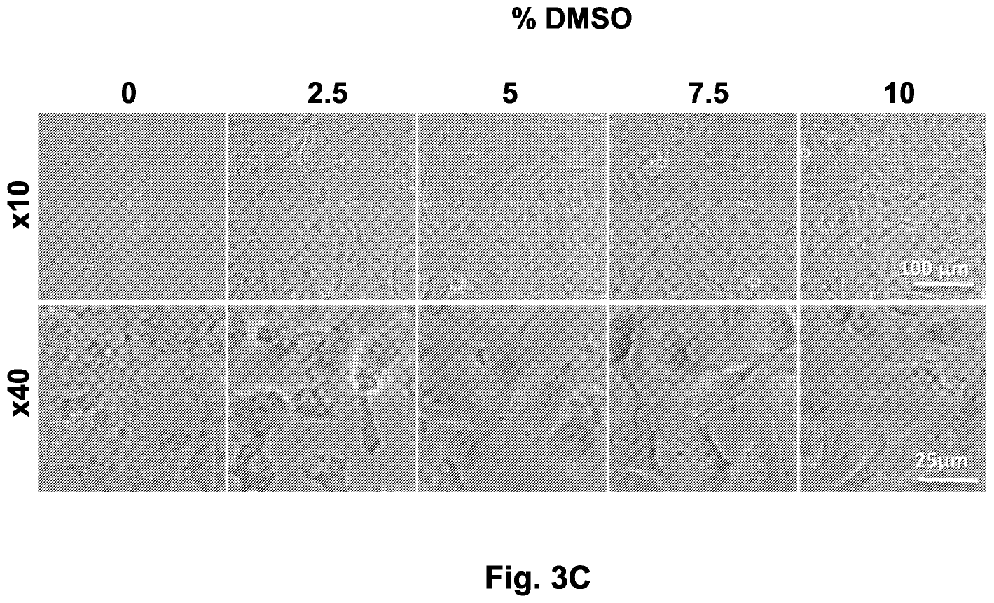

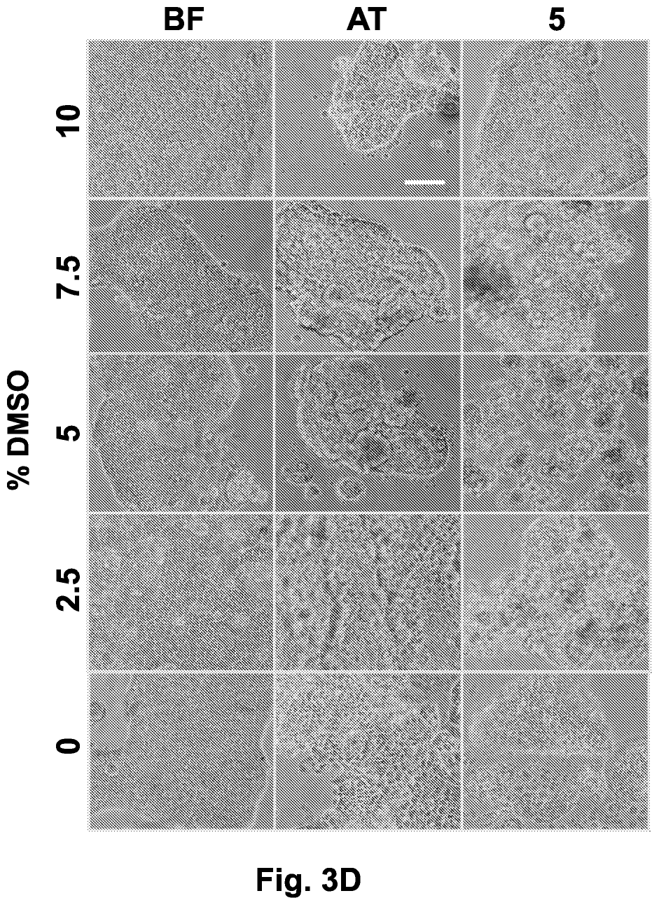

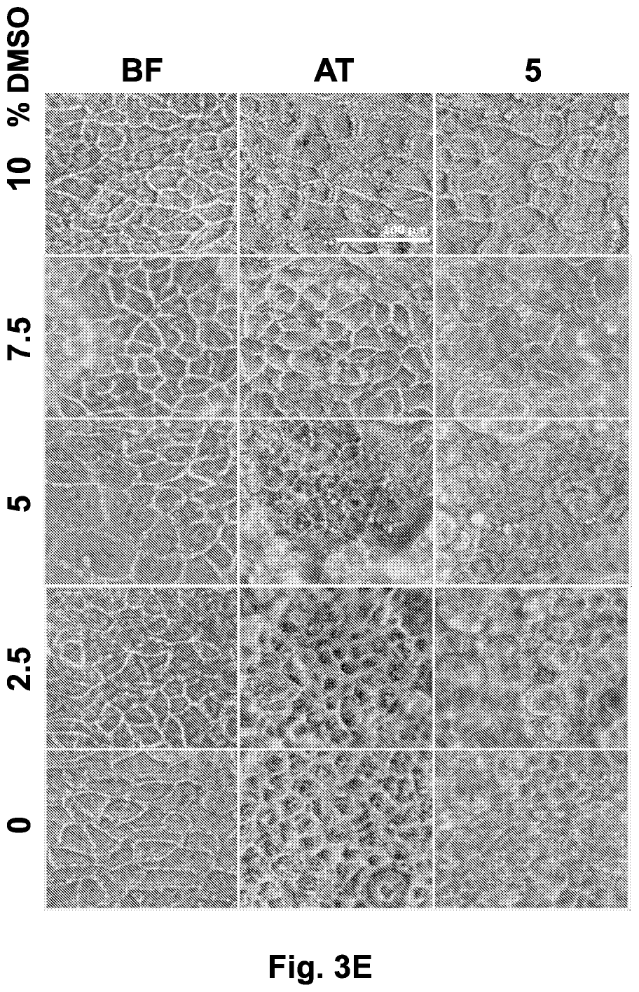

The effect of DMSO concentration in the freezing medium on cell survival was tested by gradually reducing the concentration of DMSO in the freezing medium from 10%, typically used for IEC-18 and many other cell types, down to 0%. As shown in FIG. 3A, higher DMSO concentrations increased the ice crystal branching instabilities, as expected for higher solute concentrations, but the typical crystal size did not change significantly with the DMSO concentration at that velocity (30 μm/sec). Therefore, it is unlikely that ice crystal morphologies played an important role in cell survival here.

The morphologies of the IEC-18 cells after thawing (FIG. 3B) and after 5 hours incubation (FIG. 3C) appeared normal in the majority of cells preserved using 10%, 7.5%, or 5% DMSO concentrations. In 2.5% DMSO, most cell fractions included injured cells with a few cells exhibiting healthy morphologies, although these cells remained attached to the substrate. This fact indicates that the majority of cellular injury at low DMSO concentrations resulted from intracellular freezing rather than the loss of adhesion to the substrate. In 0% DMSO, all cells appeared severely injured and fragmented.

Assessing the minimum concentration of DMSO needed for successful cryopreservation using the directional freezing protocol revealed that at a translational speed of 30 μm/sec, the DMSO concentration could be reduced by at least a factor of 2, from 10% to 5%, for the IEC-18 cells (FIGS. 3B and 3C). By contrast, reducing the DMSO concentration to 5% was destructive for the Caco-2 cells in the adherent setup (FIGS. 3D and 3E). In addition, most of the layer peeled away at lower DMSO concentrations, in agreement with the observation that Caco-2 cells detach from a substrate under specific signaling. Surface activation and coating with extracellular matrix (ECM) might further improve cell attachment.

### Example 4

Gradual Cooling Rate from −20° C. to −80° C. Affects Cell Morphology

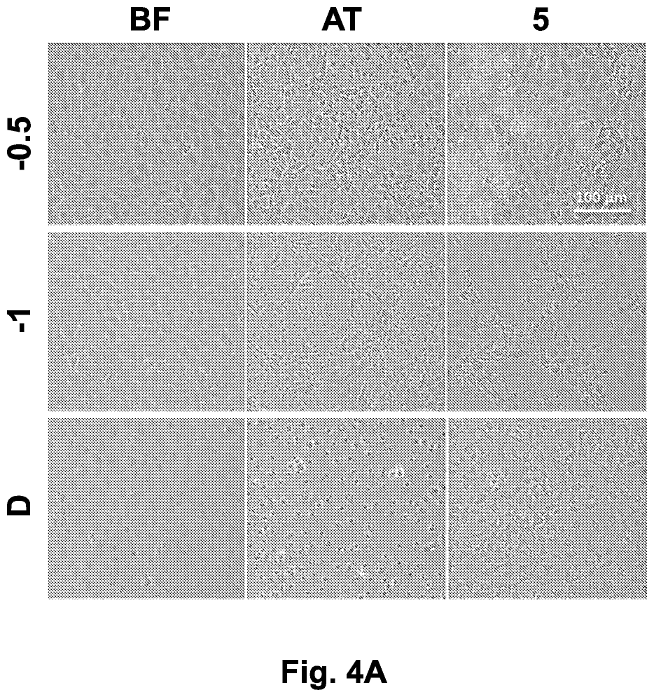

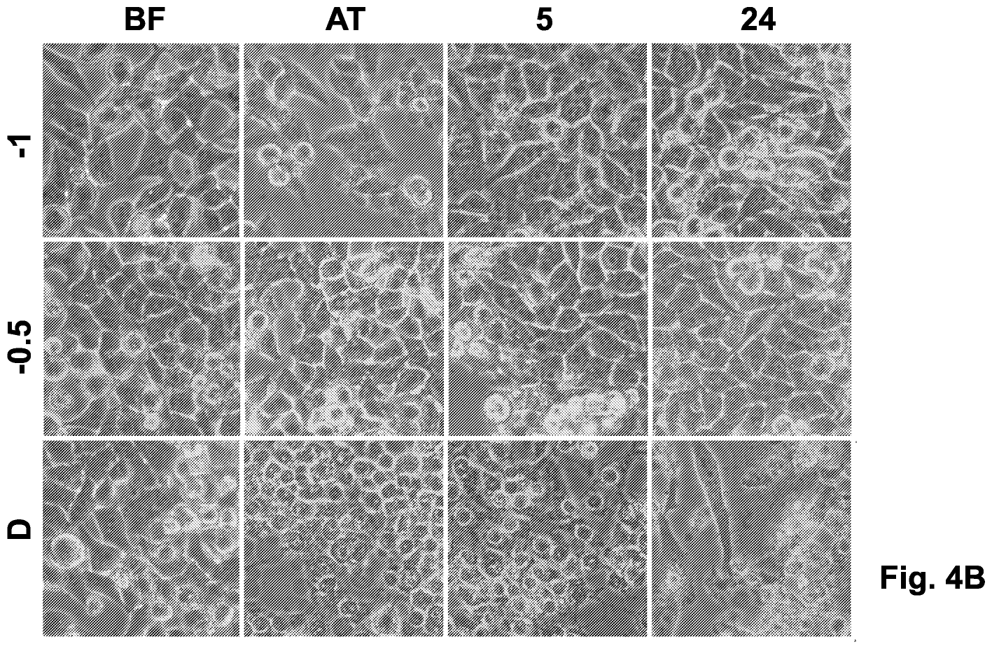

After directional freezing and gradual cooling of IEC-18 cells down to −20° C. on the translational cryostage, the samples were transferred to the liquid nitrogen flow cooling stage, and gradually cooled down to −80° C., below the glass transition temperature. The differences between the typical cooling rate of −1° C./min, a slower cooling rate of −0.5° C./min, and direct storage at −80° C. were tested. As shown in FIG. 4A, both the −1° C./min and direct −80° C. approaches yielded cells with an injury phenotype, similar to that obtained in the fast directional freezing case (90 μm/sec, as shown in FIG. 2B) or at low DMSO concentrations (0% and 2.5% DMSO, as shown in FIGS. 3B and 3C). The injury phenotype was characterized by intracellular freezing damage, as indicated by a dark cytosol and intercellular network disruption. Gradual cooling from −20° C. to −80° C. dramatically increased the survival of the cells in comparison to direct storage at −80° C., under which conditions survival rates were practically zero even after 5 hours post-thawing incubation. Lowering of the cooling rate to −0.5° C./min resulted in an even higher survival rate among cells in the monolayer. Similar results were obtained with HeLa human cervical cancer cells (FIG. 4B). Interestingly, −40° C. appeared to be a critical point, such that cells above this temperature prior to transfer to the −80° C. freezer did not survive, whereas cells below this temperature prior to transfer survived at a significantly higher survival rate.

### Example 5

### Validation of the Optimal Parameters for Directional Freezing of Cells

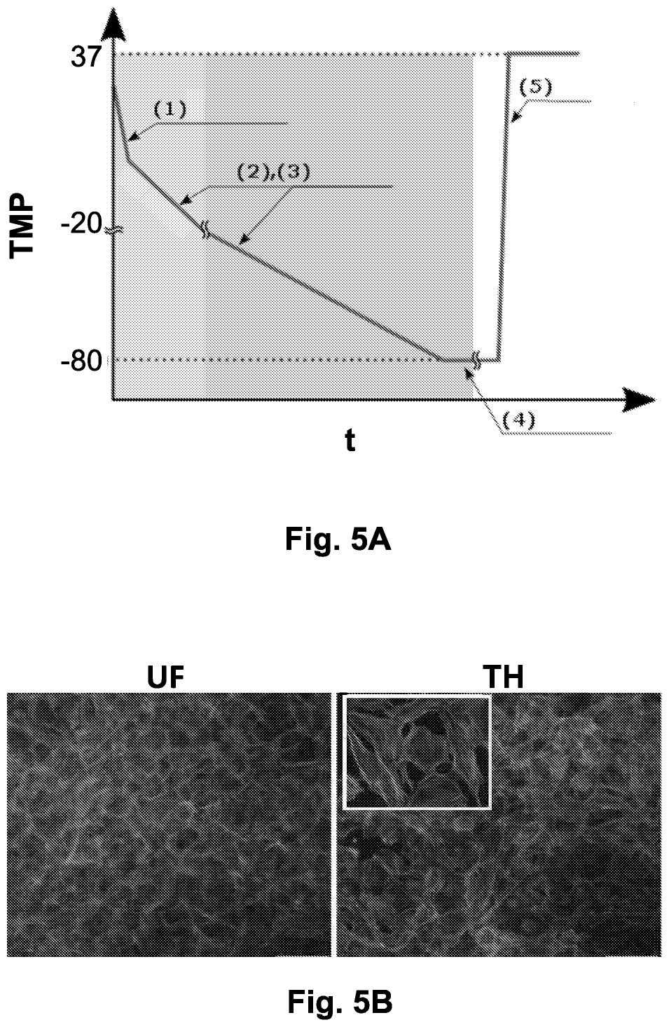

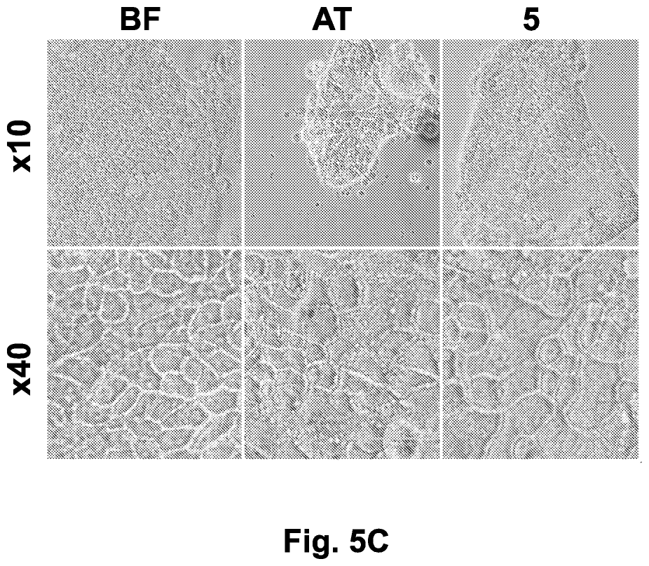

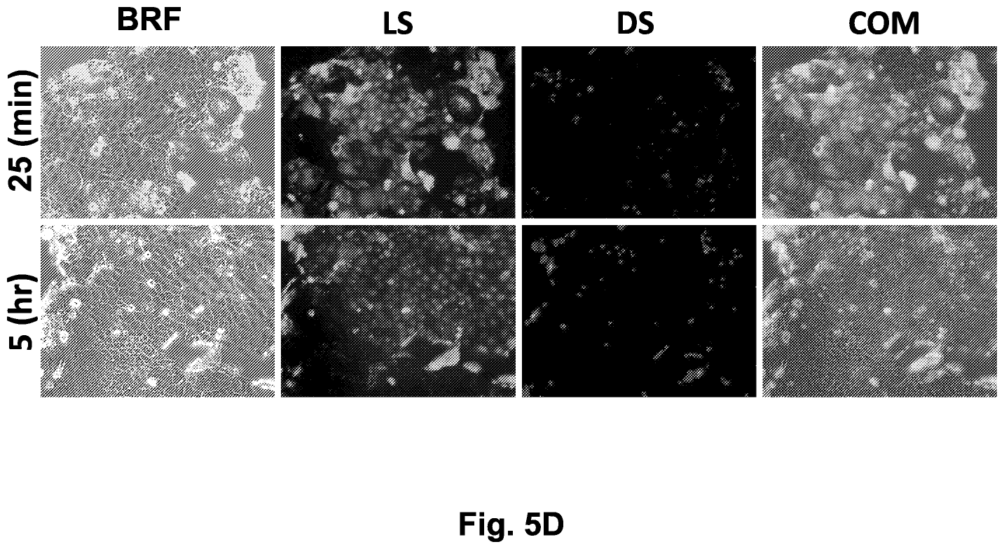

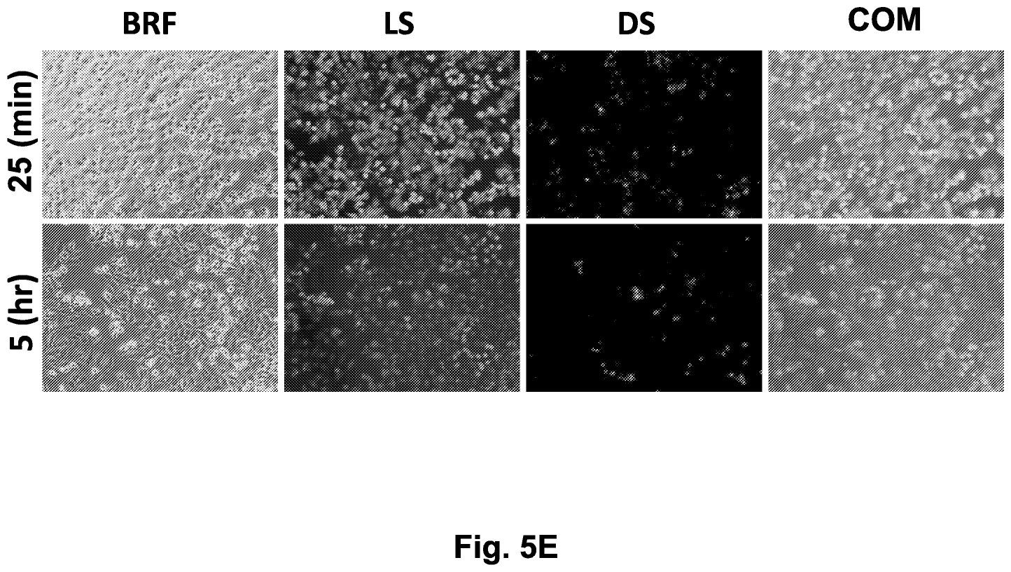

In light of the above results, the optimal parameters for directional freezing of IEC-18 cells, as shown in FIG. 5A, were determined to be as follows:
freezing solution containing 7.5%-10% DMSO (v/v);
directionally freezing (step (b) of the method) at a translational velocity of 30 μm/sec;
gradually cooling (step (c)) on the translational stage down to −20° C. at a rate of −1.2° C./min; and
gradually cooling to −80° C. on the liquid nitrogen flow cooling stage at a rate of −0.5° C./min.

Afterwards, the cells can be stored at −80° C. or in liquid nitrogen and thawed when needed.

As shown in FIG. 5B, F-actin framework remained intact in thawed cells after directional freezing, similar to the unfrozen control cells.

Similar to the successful recovery of IEC-18 rat intestine epithelial cells after directional freezing using the optimized parameters as specified above, Caco-2 human colorectal adenocarcinoma cells also showed intact monolayers with normal cell shapes and bright clear nuclei after 5 hour post-thawing incubation (FIG. 5C). Live/dead labeling of Caco-2 cells also showed successful recovery of the cells, as the majority of the cells where positive for live staining (FIG. 5D). Similar results were obtained for HeLa cells (FIG. 5E).

### Example 6

### Directional Freezing Improves Cell Survival Compared to Non-Directional Freezing

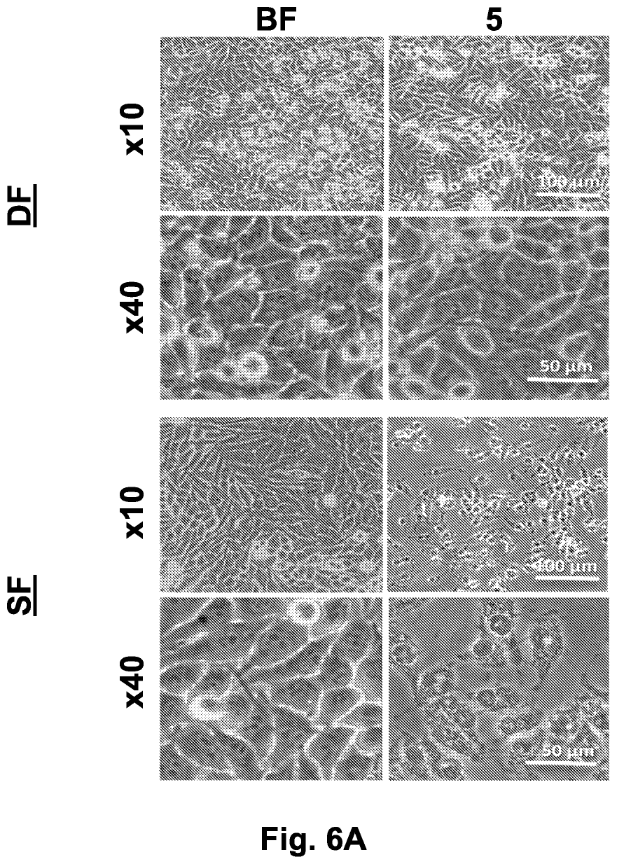

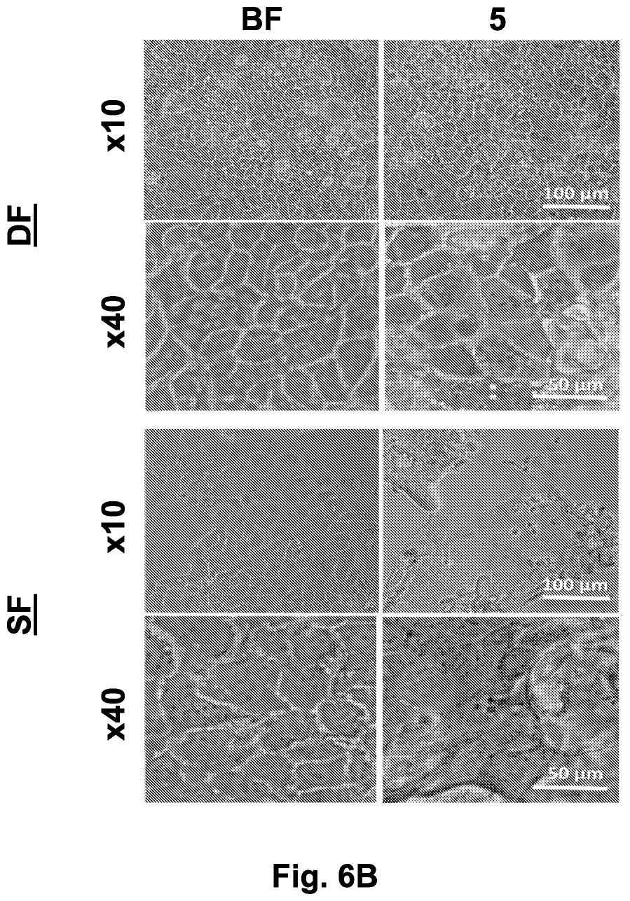

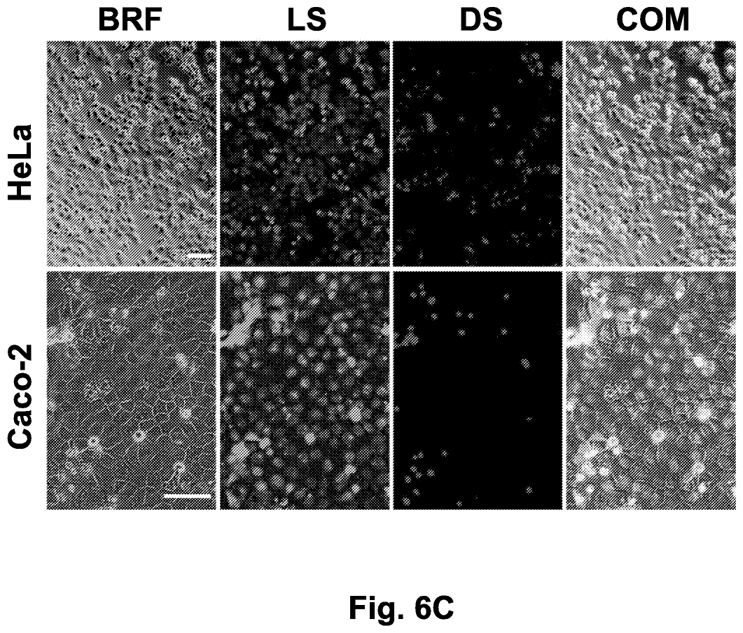

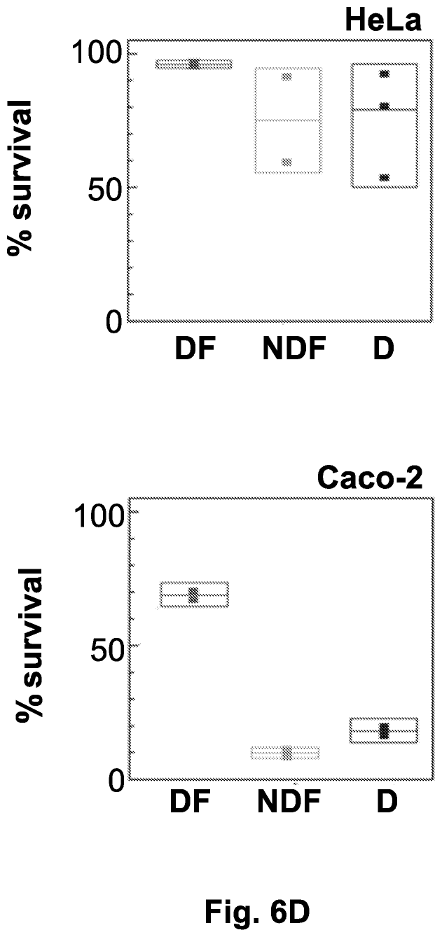

Directional freezing of the two ubiquitous human cell lines, HeLa and Caco-2 cells, using the optimal parameters identified from the IEC-18 cell tests (namely, directional cooling at a speed of 30 μm/sec, gradual cooling to −20° C. at −1.2° C./min and then to −80° C. at −0.5° C./min), was investigated in comparison to non-directional freezing, which involved the same cooling steps as directional freezing, without the directional movement at 30 μm/sec, or to slow freezing, consisting of solely cooling the cells to −80° C. at a rate of −1° C./min. Bright field images of the cells (collected 5 hours post thawing) clearly reveal that both HeLa and Caco-2 cell survival was significantly higher under the directional freezing approach as compared to the slow freezing (FIGS. 6A and 6B). Samples subjected to directional freezing were characterized by intact monolayers with normal cell shapes and bright clear nuclei. On the other hand, samples that were cryopreserved using slow freezing appeared to include darker cells that lost their cell-cell attachments within the monolayer. Interestingly, many of the Caco-2 cells detached from the glass slide during the thawing procedure. The cells that remained on the slide usually showed abnormal morphologies in the case of slow freezing, whereas under directional freezing, they appeared healthy. Surface activation and coating with ECM might further improve cell attachment.

Next, the survival rates of the cells after cryopreservation using the different regimens were tested using a live/dead staining assay, and the results were analyzed using fluorescence imaging and FACS analysis. The HeLa cells that underwent cryopreservation under directional freezing according to the invention showed consistently high rates of survival (90-100%) after thawing, as observed in the fluorescence microscopy images (FIG. 6C) and FACS results (FIG. 6D). By contrast, other cryopreservation methods, such as non-directional freezing and direct storage in −80° C. refrigerator, applied to HeLa cells showed variable results, with as low as a 50% survival rate after thawing. Similar studies of Caco-2 cells revealed even greater advantages under the directional freezing scheme, with up to 60% cell survival after thawing, compared to 20-30% survival rate using the non-directional slow freezing and direct −80° C. methods (FIGS. 6C and 6D).

### Example 7

### Robustness of the Optimized Cryopreservation Protocol

Out of over 100 independent cryopreservation experiments carried out, 75% of the data were analyzed for survival rates based on cell morphology assessments 24 hours after thawing, and the rest were removed due to technical failures during the experiments. Use of the optimized protocol, as shown in FIG. 5A, involving a 7.5-10% DMSO freezing medium provided significantly higher survival rates of 88.3% over 43 experiments, whereas the non-directional freezing at −0.5° C./min or slow freezing at −1° C./min yielded a very low survival rate of 14.3% over 14 experiments. Successful survival was defined as the majority of the cells on the slide having a normal morphology after incubation for 24 hours after thawing.

1. Method for cryopreservation of a biological sample of cells and/or intact multicellular ensembles comprising:
(a) adding a freezing solution to the biological sample;
(b) directionally freezing the sample by moving it along a temperature gradient; and
(c) gradually cooling the sample to a temperature selected from a group consisting of: at least −20° C., at least −30° C., at least −60° C., and at least −80° C.,
wherein,
(i) the cells and/or multicellular ensembles are adhered to a substrate and to each other;
(ii) the method is performed without detaching the cells and/or multicellular ensembles from the substrate or from each other before freezing; and
(iii) the cells and/or multicellular resemble have a revival rate of more than 50% of the cells in the sample upon thawing.

2. The method according to claim 1 further comprising:
(d) deep cooling the sample to a temperature of between −196° C. to −210° C.

3. The method according to claim 1, wherein step (b) is carried out along a temperature gradient selected from the group consisting of: from room temperature to −80° C., from 4° C. to −10° C., and from 4° C. to −2.5° C.

4. The method according to claim 1, wherein step (b) is carried out on a precooled motorized translational cryostage.

5. The method according to claim 1, wherein step (b) is carried out at a velocity of 0.1-500 μm/sec.

6. The method according to claim 5, wherein step (b) is carried out at a velocity of 1-100 μm/sec.

7. The method according to claim 6, wherein step (b) is carried out at a velocity of 30 μm/sec.

8. The method according to claim 1, wherein in step (c) the sample is gradually cooled to a temperature of −20° C. at a rate of −1.2° C./min and wherein the sample is further gradually cooled to a temperature of −80° C. at a rate of −0.5-−1° C./min.

9. The method according to claim 1, wherein the biological sample adhered to a substrate is selected from a primary cell culture, an immortalized cell line culture, a biopsy sample, and a multicellular complex or a combination of multiple cell types.

10. The method according to claim 1, wherein the substrate is selected from a glass slide, a glass cover-slip, an extracellular matrix, a biocompatible scaffold, Permanox dish or slide, a plastic dish, a multi well plate, a polydimethylsiloxane (PDMS) chip, or a microfluidic chip.

11. The method according to claim 1, wherein the freezing solution comprises a cryoprotective agent selected from DMSO, glycerol, ethylene glycol, polyethylene glycol (PEG), propylene glycol, polypropylene glycol, sucrose, trehalose, dextrose, dextran, polyvinylpyrrolidone, polyvinyl alcohol (PVA) and an ice binding protein.

12. The method according to claim 11, wherein the cryoprotective agent is DMSO, at a concentration of 5%-10% v/v.

13. The method according to claim 1, wherein prior to step (a) the sample is preconditioned by modification of one or more genes, induction of a specific differentiation state, or altered expression of one or more proteins, or any combination thereof.

14. A method for cryopreserving a biological sample of cells and/or intact multicellular ensembles comprising:
(a) adding a freezing solution to the biological sample;
(b) directionally freezing the sample by moving said sample along a temperature gradient on a precooled motorized translational cryostage at a velocity of 30 μm/sec, thereby the temperature of the biological sample is reduced from 4° C. to −2.5° C.;
(c) gradually cooling the sample on the translational cryostage to −80° C. at a rate of between −0.5° C./min to −1.2° C./min; and optionally
(d) deep cooling of the sample to −196° C.,
wherein,
(i) the cells and/or multicellular ensembles are adhered to a substrate and to each other;
(ii) the method is performed without detaching the cells and/or multicellular ensembles from the substrate or from each other before freezing; and
(iii) the cells have a revival rate of more than 50% of the cells in the sample upon thawing.

15. The biological sample of cells and/or intact multicellular ensembles cryopreserved according to the method of claim 1.

16. (canceled)

17. The biological sample of cells and/or multicellular ensembles according to claim 15, wherein the revival rate is at least 70%-90% of the cells in the sample upon thawing.

18. The biological sample of cells and/or multicellular ensembles according to claim 15, wherein the cells in the sample exhibit a modification of one or more genes, a specific differentiation state, or an altered expression of one or more proteins, or any combination thereof.
